(19) United States
(12) Patent Application Publication
(10) Pub. No.: US 2025/0225676 A1
(43) Pub. Date: Jul. 10, 2025

(54) A METHOD FOR DETERMINING THE 6D POSE OF A CAMERA USED TO ACQUIRE AN IMAGE OF A SCENE USING A POINT CLOUD OF THE SCENE AND FEATURES

(71) Applicants: TOYOTA JIDOSHA KABUSHIKI KAISHA, Toyota-shi Aichi (JP); ETH ZURICH, Zurich (CH)

(72) Inventors: Wim ABBELOOS, Brussels (BE); Daniil EMTSEV, Zurich (CH); Danda Pani PAUDEL, Zurich (CH); Vaishakh PATIL, Zurich (CH); Anton OBUKHOV, Zurich (CH); Luc VAN GOOL, Zurich (CH)

(73) Assignees: TOYOTA JIDOSHA KABUSHIKI KAISHA, Toyota-shi Aichi (JP); ETH ZURICH, Zurich (CH)

(21) Appl. No.: 18/851,443

(22) PCT Filed: Mar. 28, 2022
(86) PCT No.: PCT/EP2022/058167

§ 371 Date: Sep. 26, 2024

(51) Int. Cl. G06T 7/73

(52) U.S. Cl. CPC G06T 7/73; G06T 2207/10028; G06T 2207/20084; G06T 2207/30244

(57) ABSTRACT

A method for determining the 6D pose of a camera used to acquire an image of a scene using a point cloud of the scene includes a plurality of consecutive iterations each associated with a level of a plurality of consecutive levels. The method includes obtaining an initial 6D pose, obtaining one feature map having the same resolution as the image, —obtaining one plurality of features, wherein each feature of the plurality of features is associated with a respective point of the point cloud, determining an error between the features, minimizing the determined error for the 6D pose to obtain an intermediary 6D pose, and determining the 6D pose.

### CROSS-REFERENCE TO RELATED APPLICATION

This application is a U.S. National Phase application of PCT/EP2022/058167 filed Mar. 28, 2022, which is herein incorporated by reference.

### BACKGROUND

### 1. Technical Field

The present disclosure is related to the field of image processing, and more precisely to the field of registering images to point clouds and determining the 6D pose of a camera used to acquire an image of a scene.

### 2. Description of Related Art

It has been proposed to process images through such neural networks, for example to detect objects on images. Typically, in a training phase, known images are inputted to the neural network and a scoring system is used to adjust the neural network so that it behaves as expected on these known images. The neural networks are then used in a phase called a testing phase on actual images without any knowledge of the expected output.

The expression “neural network” used in the present application can cover a combination of a plurality of known networks.

In some applications, 2D images and 3D images (or point clouds) are available. In these applications, it may be desirable to know the location of the camera used to acquire the 2D image, in a process often called registration. This then allows determining the location of objects surrounding the camera, which can be identified using neural networks.

Obtaining the 6D pose of a camera used to acquire a 2D image remains a challenge. Often, prior art solutions rely on geometry-based correspondences between 2D and 3D keypoints to solve what is called the PnP process (Perspective and Pose).

The known techniques are still not satisfactory.

### SUMMARY

The present disclosure overcomes one or more deficiencies of the prior art by proposing a method for determining the 6D pose of a camera used to acquire an image (i.e. a 2D image, for example a digital image) of a scene using a point cloud of the scene (i.e. the scene visible on the image), the method comprising a plurality of consecutive iterations each associated with a level of a plurality of consecutive levels and comprising:
obtaining an initial 6D pose,
obtaining, from a processing of the image using an image processing neural network configured to receive the image as input, and configured to be able to output, for the level of the iteration, which is a level in the image processing neural network:
   one feature map having the same resolution as the image,
obtaining, from a processing of the point cloud using a point cloud processing neural network configured to receive the point cloud as input, and configured to be able to output, for the level of the iteration, which is a level in the point cloud processing neural network (the i-th level of the iteration also designates the i-th level in the image processing neural network and the i-th level in the point cloud processing neural network, also, a level is the output of a neural network layer):
   one plurality of features, wherein each feature of the plurality of features is associated with a respective point of the point cloud,
determining an error (for example by expressing it in a mathematical function) which decreases when every feature of every point of the point cloud is close to every feature in the feature map at the pixel location (of the feature map) corresponding to the projection of this point of the point cloud on the image when the camera is at the initial 6D pose, and which increases otherwise,
minimizing the determined error for the 6D pose to obtain an intermediary 6D pose,
determining the 6D pose to be used in the subsequent iteration as the initial 6D pose or to be used as the 6D pose of the camera (this last alternative applies to the final iteration, for the last level, the one closer to the output of the two neural networks).

Thus, two different neural networks are used, an image processing neural networks, having a number of input neurons that allows receiving images, and a point cloud processing network having a number of input neurons that allows receiving point clouds. These two neural networks can be used in each iteration or even in a single iteration (for example the first one). If processing the point cloud and processing the image is not performed in an iteration, the obtaining steps can comprise retrieving the features from a memory where they are stored.

The image processing neural network delivers a plurality of feature maps, each associated with a level of the neural network. The levels are consecutive in the sense that they are ordered, from the input to the output of the neural network, however, two consecutive levels may be separated by any number of neural network layers.

The point cloud processing neural network delivers several pluralities of features, each plurality being associated with a level of the point cloud processing neural network. Here, the levels are also consecutive in the sense that they are ordered, from the input to the output of the point cloud processing neural network, however, two consecutive levels may be separated by any number of point cloud processing neural network layers.

The person skilled in the art will be able to select where the levels are located in the two neural networks.

The features outputted by the image processing neural network and by the point cloud processing neural network are vectors having a given length or depth. The depth for one level is usually always the same for the features of this level, and the depth can be the same for all the levels.

Thus, the above method proposes to obtain features from the image and the point cloud, and to use their closeness to perform the determination of the 6D pose. In other words, a registration is performed on the features and not on the image/point cloud directly.

A preliminary training phase of the two neural networks may favour the output of features which are similar between the image and the point cloud for a same location when the camera has the correct 6D pose to project the point cloud features.

It should be noted that the initial 6D pose is optimized when the method is carried out, and that this initial 6D pose can be provided or determined in a prior phase in which the method has been applied to another image.

According to a particular embodiment, the image processing neural network is further configured to output, for the level of the iteration, one uncertainty map being associated with the feature map and having the same resolution as the feature map, obtained in the obtaining step using the processing by the image processing neural network, and wherein the point cloud processing neural network is further configured to output, for the level of the iteration, one uncertainty value for each feature of the plurality of features, obtained in the obtaining step using the processing by the point cloud processing neural network, the method further comprising computing, for each point of the point cloud and for the level of the iteration, a confidence value using the at least one uncertainty map and the uncertainty values, the confidence value being configured to indicate a high confidence if the feature of the point of the point cloud is close to the feature in the feature map at the pixel location corresponding to the projection of this point of the point cloud on the image when the camera is at the initial 6D pose, and a low confidence if they are remote from one another.

and wherein computing the error comprises computing a sum of distances between every feature of every point of the point cloud and the feature in the feature map at the pixel location corresponding to the projection of this point of the point cloud on the image when the camera is at the initial 6D pose, wherein each distance is multiplied by the confidence value associated with the feature of the point cloud and the feature in the feature map at the pixel location corresponding to the projection of this point of the point cloud on the image when the camera is at the initial 6D pose.

It has been observed that also outputting these uncertainty maps improves the performance of the method.

Also, the confidence values can, through the training, indicate whether an image location is directed to important information for localization, for example a specific pattern, a window on a building. They can also indicate (for example when their value is low) a homogeneous region useless for determining the 6D pose.

They can also, through the training, indicate whether a point in the point cloud is relevant for determining the 6D pose, typically a relevant point. Also, they can indicate that a point is useless.

For example, a high confidence can mean that there is a higher probability of a point getting projected at the image to the right/correct position. A high confidence also means that there is a higher probability that this place of the image would correspond to 3D points (the point is more useful for localization or corresponds to a more meaningful geometric place.

According to a particular embodiment, computing the confidence value is performed using the following equation:

$${w}^{i} ( R , t ) = \frac{1}{1 + {u}_{p}^{i}} \frac{1}{1 + {U}_{I} ( {Π}_{K} ( {Rp}^{i} + t ) )}$$

wherein wⁱ(R,t) is the confidence value for point pⁱ of a point cloud,
(R,t) is the initial 6D pose, with (R,t)∈SE(3),
uₚⁱ is the uncertainty value for point pⁱ of the point cloud,
Π_{K}(Rpⁱ+t) is the result of the projection of point pⁱ at the pixel location corresponding to the projection of this point of the point cloud on the image when the camera is at the initial 6D pose, and
Uₗ(Π_{K}(Rpⁱ+t)) is the uncertainty value in the uncertainty map the pixel location corresponding to the projection of this point of the point cloud on the image when the camera is at the initial 6D pose,
and wherein determined the error is performed using the following equation:

$$E ( R , t ) = {\sum }_{i , k} {w}^{ik} ( R , t ) {‖ {f}_{p}^{ik} - {F}_{I}^{k} ( {Π}_{K} ( {Rp}^{i} + t ) ) ‖}_{γ}$$

wherein k indicates the level of the present iteration and i indicates the point in the point cloud,
E(R,t) is the error,
fₚ^{ik} is the feature of point pⁱ of the point cloud,
Fₗ^{k}(Π_{K}(Rpⁱ+t)) is the feature in the feature map at the pixel location corresponding to the projection of this point of the point cloud on the image when the camera is at the initial 6D pose.

In the above formula, the distance indicated by ∥x∥_{y} can be, for example, the Huber loss function.

According to a particular embodiment, minimizing the determined error comprises using the Levenberg-Marquardt algorithm.

Here, a function has to be minimized and this can be formulated as a non-linear least squares minimization. Some possible solutions are Gaussian-Newton or gradient descent methods. The Levenberg-Marquardt algorithm is a combination of Gaussian-Newton methods and of gradient descent methods. Thus, the Levenberg-Marquardt algorithm interpolates between gradient descent methods and Gaussian-Newton methods. This leads to providing a faster convergence than the gradient descent methods (large damping factor, i.e. infinity) or the Gaussian-Newton methods (small damping factor, i.e. 0). The speed of convergence can be controlled by the damping factor, usually called 2. Document “The Levenberg-Marquardt Algorithm” (Ananth Ranganathan, 2004, available online in March 2022 at the following URL:

http://citeseerx.ist.psu.edu/viewdoc/summary?doi=10.1.1.10.2258) discloses the details of this algorithm.

According to a particular embodiment, the method further comprises after all the iterations have been carried out to obtain a final 6D pose of the camera, assigning a colour to every point of the point cloud projectable on the image when the camera is at the final 6D pose using the colour information of the image.

According to a particular embodiment, the method comprises determining the 6D pose of a camera used to acquire each image of a plurality of consecutive images of scenes using corresponding a point clouds of the scenes, and wherein after all the iterations have been carried out to obtain a final 6D pose of the camera of the first image, the final 6D pose is used as the initial 6D pose for N consecutive images.

According to a particular embodiment, the method comprises providing a reference image showing a reference scene, a reference point cloud of the reference scene, and a corresponding reference pose of the camera used to acquire the reference image, wherein the point cloud of the scene overlaps the point cloud of the reference point cloud of the reference scene, the method further comprising, after all the iterations have been carried out to obtain a final 6D pose of the camera of the first image, optimizing the final 6D pose using the reference pose of the camera used to acquire the reference image.

According to a particular embodiment, the method comprises a preliminary joint training phase of the image processing neural network and of the point cloud processing neural network.

The present disclosure also provides a system configured to perform the method as defined above in any one of its embodiments.

In one particular embodiment, the steps of the method are determined by computer program instructions.

Consequently, the present disclosure is also directed to a computer program for executing the steps of a method as described above when this program is executed by a computer.

This program can use any programming language and take the form of source code, object code or a code intermediate between source code and object code, such as a partially compiled form, or any other desirable form.

The present disclosure is also directed to a computer-readable information medium containing instructions of a computer program as described above.

The information medium can be any entity or device capable of storing the program. For example, the medium can include storage devices such as a ROM, for example a CD ROM or a microelectronic circuit ROM, or magnetic storage device, for example a diskette (floppy disk) or a hard disk.

Alternatively, the information medium can be an integrated circuit in which the program is incorporated, the circuit being adapted to execute the method in question or to be used in its execution.

### BRIEF DESCRIPTION OF THE DRAWINGS

Further features and advantages of the present disclosure will become apparent from the following description of certain embodiments thereof, given by way of illustration only, not limitation, with reference to the accompanying drawings in which:

FIG. 1 is a schematic illustration of the method according to an example.

FIG. 2 is also a schematic illustration of the method according to an example.

FIG. 3 shows the steps of an iteration of the method.

FIG. 4 is a schematic illustration of a system according to an example.

FIG. 5 shows how a reference image is used.

### DETAILED DESCRIPTION OF EMBODIMENTS

We will now describe a method for determining the 6D pose of a camera used to acquire an image of a scene using a point cloud of the scene. The present method can therefore be used in applications where a camera acquire a 2D image of a scene and, close to the camera, a device such as a Light detection and ranging (LiDAR) detector acquires a point cloud of the same scene.

It should be noted that the method will perform better when the scene that can be observed on image is entirely present on the point cloud. However, a partial overlap between the two is also possible: the image can show a portion of the scene not present in the point cloud, and the point cloud can show (or at least comprise points corresponding to) a portion of the scene not present in the image.

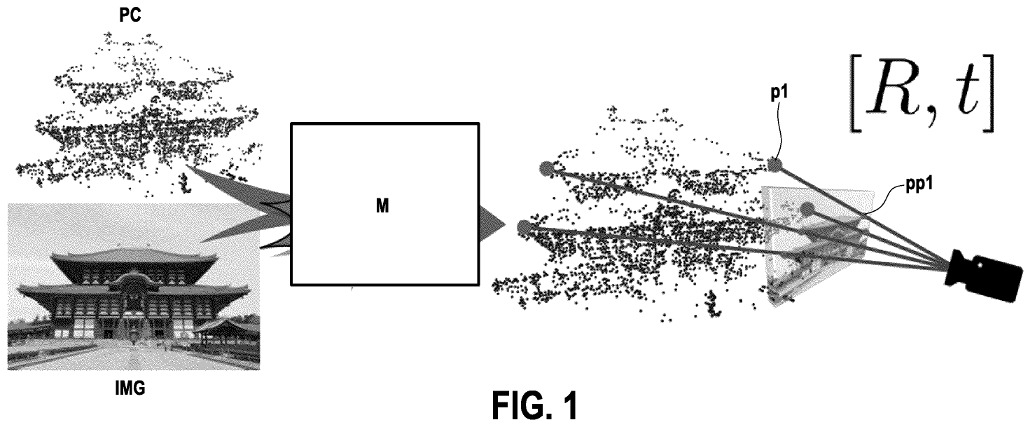

FIG. 1 is a schematic representation of the operation of the method designated as M on the figure. The method receives as input a 2D image (or image) IMG acquired by a 2D camera, and a point cloud PC, for example acquired by a LiDAR detector. The output of the method is the pose of the camera used to acquire the 2D image IMG, denoted as [R,t] on the figure.

It appears that in the present application, the 6D pose is expressed using the SE(3) group, by a rotation R and a translation t. Other notations may also be used.

As can be seen on the figure, which is a representation of the operation of the method, for a point p1 of the point cloud, the method will match this point with the corresponding point in the 2D image. More precisely, the method will do so by matching a feature of a point of the point cloud with a feature for the projection pp1 of this point in the image, the two features being obtained by a neural network.

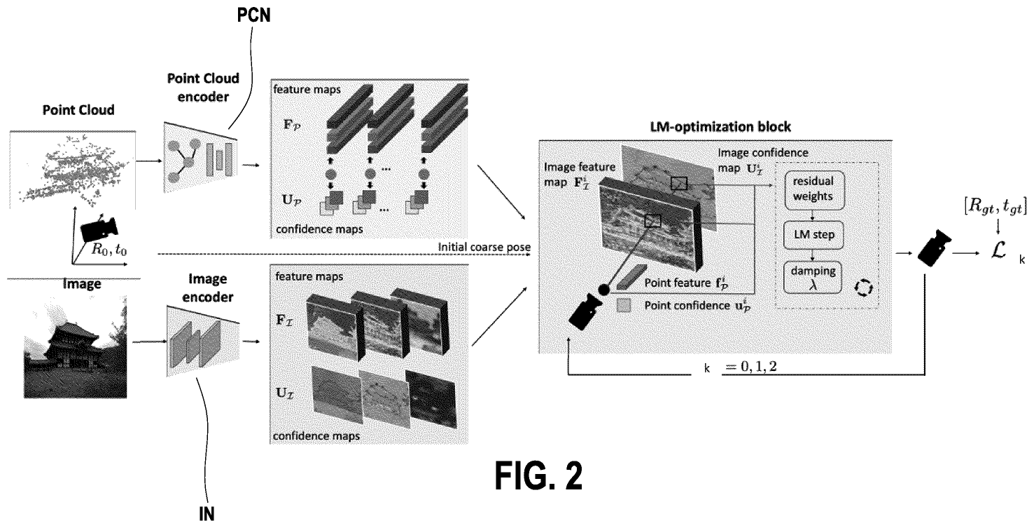

FIG. 2 shows schematically but in greater detail the operation of the method when processing a point cloud PC and an image IMG, using a point cloud processing neural network PCN and an image processing neural network IN.

We will now describe how features are obtained from the point cloud.

A point cloud processing neural network PCN is provided to be able to receive as input a point cloud.

We note the point cloud P={pⁱ}_{i=1′}ⁿ with each point pⁱ having for example three coordinates in space.

The point cloud processing neural network may be based on the neural network known to the person skilled in the art as Point-kNN (Liu Liu, Dylan Campbell, Hongdong Li, Dingfu Zhou, Xibin Song, and Ruigang Yang. Learning 2d-3d correspondences to solve the blind perspective-n-point problem. arXiv preprint arXiv: 2003.06752, 2020.), and more precisely, several Point-kNN graph blocks are used. For each block, the input has a size of n×d) where the depth d is constant for every block (it should be noted that the depth can be modified after each block by applying traditional MLP layers, for example to adjust the resolution when necessary) and anchor points (as described in the above cited documents) are sampled from the input set. The k-nearest neighbors (i.e. kNN) are then computed in what is an MLP block which aggregates local features and outputs the final point-wise features.

As several point-kNN blocks are arranged in series, it is possible to extract a plurality of features at a plurality of depth levels. Here, a block is a set of layers and connections, which receives features as input and outputs features. The neural network can comprise multiple blocks and it is possible to assign a level to any position to extract features at a plurality of positions. This allows capturing the global context of the input set of points and to generate more discriminative features. The point-cloud processing neural network is also configured to deliver uncertainty values, by using the same architecture as well as MLP blocks to obtain uncertainty values for each point of the point cloud.

The operation of the point cloud processing neural network will now be described.

For a given level, we note the operation of the point cloud processing neural network ϕ(.), P the point cloud, so that:

$$ϕ ( P ) = ( Fp , Up )$$

With Fp the features Fp={fₚⁱ=ᵢ₌₁ⁿ being each associated with a point pⁱ∈P, and Up the uncertainty values Up={uₚⁱ}ᵢ₌₁ⁿ also each associated with a point pⁱ∈P. Also, the values in the uncertainty maps are always positive, here, by an exponential.

In order to learn discriminative representation of the point cloud features Fp, the techniques of the following documents is applied:
Charles R Qi, Hao Su, Kaichun Mo, and Leonidas J Guibas, Pointnet: Deep learning on point sets for 3d classification and segmentation. In Proceedings of the IEEE conference on computer vision and pattern recognition, pages 652-660, 2017.
Yue Wang, Yongbin Sun, Ziwei Liu, Sanjay E Sarma, Michael M Bronstein, and Justin M Solomon. Dynamic graph cnn for learning on point clouds. Acm Transactions On Graphics (tog), 38(5):1-12, 2019.

This allows leveraging MLP layers on the point clouds. To increase the receptive field and learn both local and global context, the kNN graph is built in the L₂ space. Encoding the global context is performed by using context normalization and feeding normalized features through batch normalization, ReLU, and shared MLP layers to output the point-wise features Fp. As explained above the point cloud processing neural network comprises blocks. Here, blocks of local and global feature encoders are repeated to construct a neural network including 12 blocks (this neural network can be called a 12-block Resnet-like neural network). In this neural network, each block includes local features on the nearest neighbors) and global (features normalization) parts. Also, the features outputted by each block can be connected (a residual connection is used).

We will now describe how features are obtained for the image using an image processing neural network IN.

The image processing neural network IN is provided having the structure known to the person skilled in the art under the name U-net. More precisely, the image processing neural network can be based on the one of document “Very deep convolutional networks for large-scale image recognition” (Karen Simonyan and Andrew Zisserman . . . arXiv preprint arXiv: 1409.1556, 2014., available in March 2022 at the following URL: https://arxiv.org/pdf/1409.1556.pdf). The neural network of this document, called the VGG-19 encoder, is a neural network initially developed for image classification. However, its layers are reused for a different purpose here. To this end, the VGG-19 network is trained on a dataset known to the person skilled in the art as ImageNet, and weights accumulated during the training process are extracted and used for other tasks. This allows leveraging the power of weights since different images share common patterns like edges, corners, etc. This procedure can be referred to as a “pre-training”. Thus, the weights of the pre-trained VGG-19 network are taken to be used in the present method. These weights are used to form a U-shape neural network, where the layers first get deeper in the left side of the U and then narrower in the right part of the U. More precisely, the weights are used in the left part (input side) of the U-shape network, and the right side of the U comprises convolutional layers fused with encoders using so-called “skip” connections.

Feature maps are extracted at different levels of the decoder, using an enlargement of the resolution (or upsampling, to adapt the resolution) if necessary to obtain the expected resolution of the input image. Uncertainty maps are also obtained at the different levels (for example using additional convolutional layers that process the extracted features), and if necessary and enlargement is performed.

For a given level, we note the operation of the image processing neural network ψ(.) and I the image, so that:

$$ψ ( I ) = ( {F}_{I} , {U}_{I} )$$

With F_{I} being a feature map having the same resolution as the image and U_{I} an uncertainty map (a map of uncertainty values) associated with the feature map and also having the same resolution as the image/the feature map.

For a given location q in the image (and in the feature and uncertainty maps), a feature F_{I}(q) and uncertainty U_{I}(q) are obtained for a given level. In fact, in a manner which is similar to what has been described before concerning the point cloud processing neural network, the feature maps and uncertainty maps are obtained for multiple levels in a manner which that can be described as coarse-to-fine (from the input to the output of the image processing neural network). Also, the values in the uncertainty maps are always positive, here, by an exponential.

We will now describe the phase of the process that can be referred to as the direct registration. Here, the registration is between an image and a point cloud that both show a same scene (or at least, a portion of the image has corresponding points in a portion of the point cloud, in some embodiments, these two portions being as large as possible), and in the present description, designates aligning image features Fr and point cloud features Fp by finding the optimal camera pose parameters (the pose of the camera that acquired the image being unknown). Here, the pose is expressed as a rotation R and a translation t, so that (R,t)∈SE(3).

With K being the camera's intrinsic matrix (considered to be known in the present description), the projection of a point p, in 3d world coordinates, to a point q in image coordinates is given as:

$$q = {\prod }_{K} ( Rp + t ) ≃ K ( Rp + t ) \qquad Eq . 1$$

With Π_{K}(·) being the projection operation performed using the camera's intrinsic matrix K.

The direct registration defined above can be written as a minimization problem:

$${min}_{( R , t ) ∈ SE ( 3 )} {\sum }_{{p}^{i} ∈ P} {‖ {f}_{p}^{i} - {F}_{I} ( {\prod }_{K} ( {Rp}^{i} + t ) ) ‖}_{2} \qquad Eq . 2$$

This amounts to finding the pose parameters such that the distance between 3D features (extracted from the point cloud processing neural network) and 2D features (extracted from the image processing neural network).

It should be noted that the two functions ψ(I) and ϕ(P) are trainable functions. A preliminary training phase can be performed as will be described hereinafter.

The above equation 2, while representing the global aim of the method, does not make use of the different levels of the two neural network (the point cloud processing neural network and the image processing neural network). This will be described hereinafter.

We will now describe how uncertainty values and uncertainty maps are used to obtain confidence values. It should be noted that the present disclosure is however not limited to using uncertainty values/maps, but that using them improves the performance of the method. In fact, it is not always possible to make use of all the point cloud features and all the image features because of the presence of occlusions, missing portions (between the point cloud and the image), or unreliable visual features. The use of uncertainty values/maps overcomes this difficulty.

For a given level, a confidence value can be computed for each point of the point cloud, using the at least one uncertainty map and the uncertainty values. The confidence value is configured to indicate a high confidence if the feature of the point of the point cloud is close to the feature in the feature map at the pixel location corresponding to the projection of this point of the point cloud on the image when the camera is at an initial 6D pose (defined hereinafter), and a low confidence if they are remote from one another.

Typically, a high confidence value indicates that in the image, there is important information for localization (typically a window, a pattern), it also means that there is a high probability that the projection is at the right location. A low confidence may also indicate a bad location or even that the image at this location does not contain a usable pattern (for example the sky). This behavior is obtained in a training phase where a ground truth will be chosen accordingly.

More precisely, the two functions ψ(I) and ϕ(P), namely the image processing neural network and the point cloud processing neural network, can be trained in a preliminary training phase.

The ground truth will be a pose (denoted [R_{gt}, t_{gt}] on FIG. 2), such that a loss Lx is computed for a level, to subsequently perform an adaptation (or optimization) of the weights of the two neural networks (for example through the gradient descent method in which a gradient is back-propagated through the two neural networks).

It should be noted that the preliminary training phase comprises a joint training. In other words, a single loss is used to perform the back-propagation in the two neural networks.

Also, this joint training comprises a training for every level of the neural network.

For example, it can be noted that the point cloud processing neural network and the image processing neural network contain weights/biases (neurons) that are optimized during this preliminary training phase so they are changing constantly.

The present method includes using the two neural networks first before using an optimization block (that performs a minimization). The optimization block can be implemented without neurons and may not have to be trained like the two neural networks (they only perform algebraic operations). The gradients that are back-propagated can however go through this block to reach the two neural networks.

Here, the confidence value for a point pⁱ∈P and for a given level is expressed as:

$${w}^{i} ( R , t ) = \frac{1}{1 + {u}_{p}^{i}} \frac{1}{1 + {U}_{I} ( {\prod }_{K} ( {Rp}^{i} + t ) )} \qquad Eq . 3$$

With uₚⁱ the uncertainty associated with point pⁱ, obtained from the point cloud processing neural network, and U_{I}(Π_{K}(Rpⁱ+t)) the uncertainty value at the uncertainty map corresponding to the projection of pⁱ on the image.

Using the confidence value in equation 2 leads to the following formulation of the problem:

$${min}_{( R , t ) ∈ SE ( 3 )} {\sum }_{{p}^{i} ∈ P} {w}^{i} ( R , t ) {‖ {f}_{p}^{i} - {F}_{I} ( {\prod }_{K} ( {Rp}^{i} + t ) ) ‖}_{γ} \qquad Eq . 4$$

It should be noted that equation 4 differs from equation 2 not only because the confidence is used, but also because the distance ∥·∥_{y} denotes the Huber loss function, which improves the robustness. By robustness, what is meant is that the Huber loss function is not sensitive to outliers. For example, large values of points will not make values of the loss function increase greatly and deviate too much from the mean value.

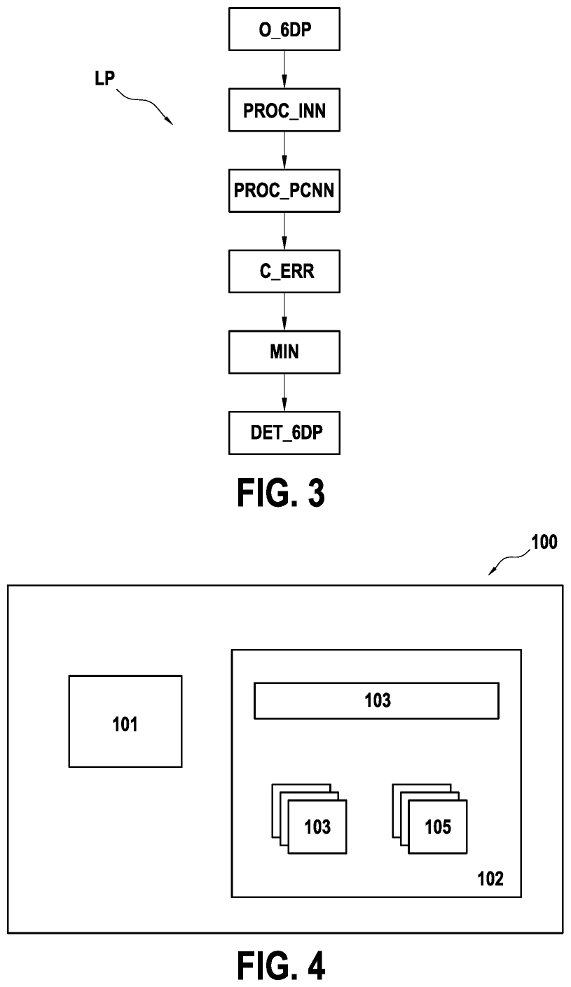

In some embodiments, the minimization problem of equation 4 is solved using the Levenberg-Marquardt to align the features of the point cloud with the features of the images, so as to find the pose of the camera. This is performed for each level, in a manner which will be explained in reference to FIG. 3.

On FIG. 3 the steps of an iteration LP of the method for determining the 6d pose are represented schematically. More precisely, the steps of a single iteration of the method, associated with a level, are represented. The method comprises a plurality of iterations, each associated with a level of the neural networks described above and these iterations are performed in accordance with the order of the levels (from the input to the output). The method can be implemented by a computer.

The first step O_6DP comprises obtaining an initial 6D pose. Typically and for the first iteration, the 6D pose can be the one obtained from a previous execution of the method (for another pair of image and point cloud). Alternatively, a random 6D pose can be used.

For any other iteration, the 6D pose is obtained from the previous iteration.

Step PROC_INN is performed in which we obtain a feature map and an uncertainty map through a processing of the image by the image processing neural network as defined above. These two maps are the ones of the level of the iteration.

It should be noted that processing the image with the image processing neural network may be performed only once for all iterations and all levels. For example, processing the image in the image processing neural network can be performed during the first iteration. For all other iterations, step PROC_INN can comprise retrieving the feature map and the uncertainty map of the level associated with the iteration from a memory where they are stored.

Step PROC_PCNN is performed in which we obtain feature values and uncertainty values associated for each point of the point cloud, for the level of the iteration, in a manner which is similar to what has been described for step PROC_INN.

Step C_ERR is then performed in which an error is determined, here using the following equation:

$$E ( R , t ) = {\sum }_{i , k} {w}^{ik} ( R , t ) {‖ {f}_{p}^{ik} - {F}_{I}^{k} ( {\prod }_{K} ( {Rp}^{i} + t ) ) ‖}_{γ} \qquad Eq . 5$$

wherein k indicates the level of the present iteration and i indicates the point in the point cloud,
E(R,t) is the error,
fₚ^{ik} is the feature of point pⁱ of the point cloud,
F_{I}^{k}(Π_{K}(Rpⁱ+t)) is the feature in the feature map at the pixel location corresponding to the projection of this point of the point cloud on the image when the camera is at the initial 6D pose,
And, as explained above, the distance ∥·∥_{y} denotes the Huber loss function.

In step MIN, the determined error is minimized for the 6D pose using the Levenberg-Marquardt algorithm.

As the Levenberg-Marquardt algorithm requires the use of a damping factor, a factor λ∈R⁶ is used. This factor can be determined first by using a set vector, for example a constant, or a vector that changes during the training phase (an additional neural network may be used to deliver λ and this additional neural network can be trained in the preliminary training phase.

The minimization can be performed using an update value δ which will then allow computing the final 6D pose, in a manner known to the person skilled in the art.

To obtain δ, which is used in the iterative minimization process that converges in accordance with δ, first, a different value is defined as:

$${r}_{k}^{i} = {F}_{I}^{k} ( {\prod }_{K} ( {Rp}^{i} + t ) ) - {f}_{p}^{ik}$$

Subsequently, the Jacobian matrix is computed:

$${J}_{i , k} = \frac{\partial {r}_{k}^{i}}{\partial δ} = \frac{\partial {r}_{k}^{i}}{\partial {p}^{i}} \frac{\partial {p}^{i}}{\partial δ}$$

The Hessian matrix is also computed as: H=J^{T}WJ

Subsequently, the update value is computed as:

$$δ = - {( H + λdiag ( H ) )}^{- 1} {J}^{T} Wr$$

Wherein r corresponds to the stack of every rₖⁱ (each rₖⁱ has dimensions of [1×D], thus r has dimensions of [N×D] with N the number of points).
And, finally, the pose, updated, can be expressed as:

$$[ R t ] = exp ( {δ}^{\hat{}} ) [ \begin{matrix}R & t \\ 0 & 1\end{matrix} ]$$

Using skew operator “\hat{ }”, wherein [Rt] on the left side of “=” is the updated pose, and R and t on the right side designate the previous pose.

In step DET_6DP, (R,t) is determined to be the 6D pose, either the output of the method if the iteration is the last iteration, or for a subsequent iteration to be used in step O_6DP.

The present method has been observed to improve determining the 6D pose, in particular over methods such as the Blind PnP method (BPnP) (Liu Liu, Dylan Campbell, Hongdong Li, Dingfu Zhou, Xibin Song, and Ruigang Yang. Learning 2d-3d correspondences to solve the blind perspective-n-point problem. arXiv preprint arXiv: 2003.06752, 2020) or the Weighted Blind PnP (W.BPnP) (Dylan Campbell, Liu Liu, and Stephen Gould. Solving the blind perspective-n-point problem end-to-end with robust differentiable geometric optimization. In European Conference on Computer Vision, pages 244-261. Springer, 2020.)

In particular, various scores that represent rotation errors, translation errors, mean runtime, have shown that the above method has a 50% gain over the W.BPnP when using the dataset called MegaDepth (Zhengqi Li and Noah Snavely. Megadepth: Learning singleview depth prediction from internet photos. In Computer Vision and Pattern Recognition (CVPR), 2018). More precisely, the median translation error is reduced by 50% (33% compared to the BPnp method).

Also, the present method has been observed to have an average run-time of 0.56 seconds, comparable with the BPnP and the W.BPnP methods.

FIG. 4 shows a system 100 for performing the method for determining the 6D pose of a camera as described in reference to FIG. 3.

System 100 may have the structure of a computer and it comprises a processor 101 and a non-volatile memory 102.

In the non-volatile memory 102, computer program instructions 103 are stored. These instructions are configured to execute the steps of a method as defined above when the program is executed by processor 101.

Additionally, the image processing neural network 104 used in the method is stored in memory 102, as well as the point cloud processing neural network 105.

We will now describe a particular embodiment of the method in which, after all the iterations have been carried out to obtain a final 6D pose of the camera, a color is assigned to every point of the point cloud projectable on the image when the camera is at the final 6D pose using the color information of the image.

It should be noted that a 3D point cloud only contains geometric information, and that this particular embodiment benefits from the accuracy of the previously described method for determining the 6D pose to colorize a point cloud

A colored point cloud is obtained.

In another particular embodiment, the method comprises determining the 6D pose of a camera used to acquire each image of a plurality of consecutive images (for example frames of a video sequence) of scenes using corresponding a point clouds of the scenes (the ones of the images), and wherein after all the iterations have been carried out to obtain a final 6D pose of the camera of the first image, the final 6D pose is used as the initial 6D pose for N consecutive images.

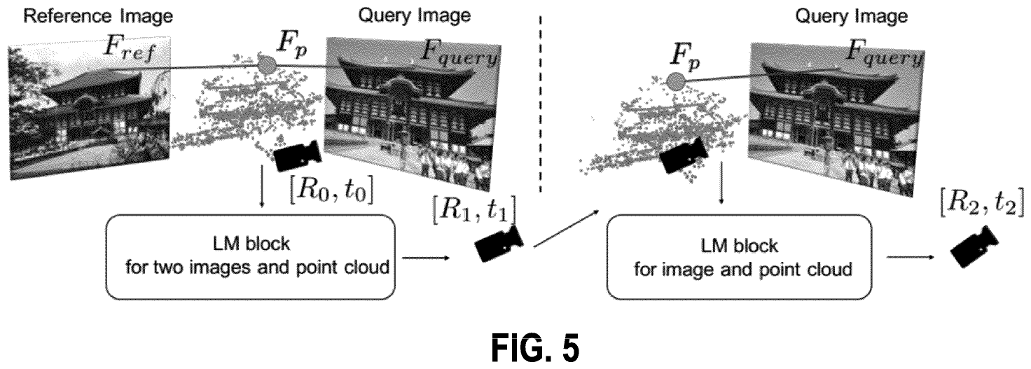

Finally, in another particular embodiment described in reference to FIG. 5, the method comprises providing a reference image showing a reference scene, a reference point cloud of the reference scene, and a corresponding reference pose of the camera used to acquire the reference image, wherein the point cloud of the scene overlaps the point cloud of the reference point cloud of the reference scene (they share some points), the method further comprising, after all the iterations have been carried out to obtain a final 6D pose of the camera of the first image, optimizing the final 6D pose using the reference pose of the camera used to acquire the reference image.

On FIG. 5, Fref designates an image processing neural network feature in the reference image, Fquery designates an image processing neural network feature in the image for which the pose is to be determined (also called the query image), and Fp designates a feature of a point of the point cloud that is projectable in both images. The optimizing can comprise using the pose determined for the reference image when applying the method for determining the 6D pose of the camera in the other image.

In a first approach, called the hybrid optimization, the error is modified (in a way, it can be said that it is made more complex). The error used in the method of FIG. 2 is modified by considering the difference between the feature from the reference image at the projection in the reference image of the point in the point cloud with the reference pose associated with the point cloud and the reference image (the pose of the camera to acquire the reference image, obtained with this point cloud), and the feature from the query image at the projection in the query image with the pose between the point cloud and the query image (this pose is predicted). Subsequently, an optimization is performed which is similar to what has been performed above in reference to FIG. 2. During the preliminary training phase, an additional image processing neural network is trained for the image/the query image. The error becomes:

$${E}_{hybrid} ( r , t ) = {\sum }_{i , k} {w}_{1}^{ik} ( R , t ) {‖ {f}_{p}^{ik} - {F}_{{I}_{query}}^{k} ( {\prod }_{{K}_{query}} ( {Rp}^{i} + t ) ) ‖}_{γ} + {\sum }_{i , k} {w}_{2}^{ik} ( R , t ) {‖ {F}_{{I}_{ref}}^{k} ( {\prod }_{{K}_{ref}} ( {R}_{ref} {p}^{i} + {t}_{ref} ) ) - {F}_{{I}_{query}}^{k} ( {\prod }_{{K}_{query}} ( {Rp}^{i} + t ) ) ‖}_{γ} with {w}_{1}^{ik} ( R , t ) = \frac{1}{1 + {u}_{Pquery}^{i}} \frac{1}{{U}_{{I}_{query}} ( {\prod }_{{K}_{query}} ( {Rp}^{i} + t ) )} And {w}_{2}^{ik} ( R , t ) = \frac{1}{1 + {U}_{{I}_{ref}} ( {\prod }_{{K}_{ref}} ( {R}_{ref} {p}^{i} + {t}_{ref} ) )} \frac{1}{1 + {U}_{{I}_{query}} ( {\prod }_{{K}_{query}} ( {Rp}^{i} + t ) )} \qquad Eq . 6$$

In equation 6, the notations are the ones of equations 1 to 5, except where indicia ref and query respectively indicate the reference and the query image (these images may have been taken by different cameras.

In a second possible approach that can be called the nested optimization, it should be noted that in the minimization/optimization, several iterations are performed. The pose is computed at the end of each iteration and provided to the next iteration. In a first iteration, it is possible to optimize a first error E₁ to obtain a new pose [R₁; t₁], this is used as input to compute a second error E₂ to get a new pose [R₂; t₂]. Subsequently, this pose is used to optimize E₁, to obtain a pose used for E₂, and so on in multiple iterations.

After several iterations, E₁ becomes the error as defined in the method described in reference to FIGS. 2, and E₂ becomes the e difference of feature from the reference image at the projection in the reference image of the point of the point cloud and the feature in the query image at the projection in the query image of the point of the point cloud (the predicted pose).

The errors can be expressed as:

$${E}_{1} = {\sum }_{i , k} {w}^{ik} ( R , t ) {‖ {f}_{p}^{ik} - {F}_{I \_ query}^{k} ( {\prod }_{K} ( {Rp}^{i} + t ) ) ‖}_{γ} \\ {E}_{2} = {\sum }_{i , k} {w}^{ik} ( R , t ) {‖ {F}_{I \_ ref}^{k} ( {\prod }_{K} ( {R}_{ref} {p}^{i} + t \_ ref ) ) - {F}_{I \_ query}^{k} ( {\prod }_{K} ( {Rp}^{i} + t ) ) ‖}_{γ} \qquad Eq . 7$$

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A method for determining a 6D pose of a camera used to acquire an image of a scene using a point cloud of the scene, the method comprising a plurality of consecutive iterations each associated with a level of a plurality of consecutive levels and comprising:
obtaining an initial 6D pose,
obtaining, from a processing of the image using an image processing neural network configured to receive the image as input, and configured to be able to output, for the level of the iteration, which is a level in the image processing neural network:
one feature map having the same resolution as the image,
obtaining, from a processing of the point cloud using a point cloud processing neural network configured to receive the point cloud as input, and configured to be able to output, for the level of the iteration, which is a level in the point cloud processing neural network:
one plurality of features, wherein each feature of the plurality of features is associated with a respective point of the point cloud,
determining an error which decreases when every feature of every point of the point cloud is close to every feature in the feature map at a pixel location corresponding to a projection of this point of the point cloud on the image when the camera is at the initial 6D pose, and which increases otherwise,
minimizing the determined error for the 6D pose to obtain an intermediary 6D pose,
determining the 6D pose to be used in a subsequent iteration as the initial 6D pose or to be used as the 6D pose of the camera using a damping factor.

2. The method according to claim 1, wherein the image processing neural network is further configured to output, for the level of the iteration, at least one uncertainty map being associated with the feature map and having the same resolution as the feature map, obtained in the obtaining step using the processing by the image processing neural network, and
wherein the point cloud processing neural network is further configured to output, for the level of the iteration, one uncertainty value for each feature of the plurality of features, obtained in the obtaining step using the processing by the point cloud processing neural network,
the method further comprising computing, for each point of the point cloud and for the level of the iteration, a confidence value using the at least one uncertainty map and the uncertainty values, the confidence value being configured to indicate a high confidence if the feature of the point of the point cloud is close to the feature in the feature map at the pixel location corresponding to the projection of this point of the point cloud on the image when the camera is at the initial 6D pose, and a low confidence if they are remote from one another, and
wherein computing the error comprises computing a sum of distances between every feature of every point of the point cloud and the feature in the feature map at the pixel location corresponding to the projection of this point of the point cloud on the image when the camera is at the initial 6D pose, wherein each distance is multiplied by the confidence value associated with the feature of the point cloud and the feature in the feature map at the pixel location corresponding to the projection of this point of the point cloud on the image when the camera is at the initial 6D pose.

3. The method according to claim 2, wherein computing the confidence value is performed using the following equation:
$${w}^{i} ( R , t ) = \frac{1}{1 + {u}_{p}^{i}} \frac{1}{1 + {U}_{I} ( {\prod }_{K} ( {Rp}^{i} + t ) )}$$
wherein wⁱ(R,t) is the confidence value for point pⁱ of a point cloud,
(R,t) is the initial 6D pose, with (R,t)∈SE(3),
uₚⁱ is the uncertainty value for point pⁱ of the point cloud,
Π_{K}(Rpⁱ+t) is a result of the projection of point pⁱ at the pixel location corresponding to the projection of this point of the point cloud on the image when the camera is at the initial 6D pose, and
U₁(Π_{K}(Rpⁱ+t)) is the uncertainty value in the uncertainty map the pixel location corresponding to the projection of this point of the point cloud on the image when the camera is at the initial 6D pose,
and wherein determining the error is performed using the following equation:
$$E ( R , t ) = {\sum }_{i , k} {w}^{ik} ( R , t ) {‖ {f}_{p}^{ik} - {F}_{I}^{k} ( {\prod }_{K} ( {Rp}^{i} + t ) ) ‖}_{γ}$$
wherein k indicates the level of a present iteration and i indicates the point in the point cloud,
E(R,t) is the error,
fₚ^{ik} is the feature of point pⁱ of the point cloud,
Fₗ^{k}(Π_{K}(Rpⁱ+t)) is the feature in the feature map at the pixel location corresponding to the projection of this point of the point cloud on the image when the camera is at the initial 6D pose.

4. The method according to claim 1, wherein minimizing the determined error comprises using the Levenberg-Marquardt algorithm.

5. The method according to claim 1, further comprising after all the iterations have been carried out to obtain a final 6D pose of the camera, assigning a colour to every point of the point cloud projectable on the image when the camera is at the final 6D pose using the colour information of the image.

6. The method according to claim 1, comprising determining the 6D pose of a camera used to acquire each image of a plurality of consecutive images of scenes using corresponding a point clouds of the scenes, and wherein after all the iterations have been carried out to obtain a final 6D pose of the camera of the first image, the final 6D pose is used as the initial 6D pose for N consecutive images.

7. The method according to claim 1, comprising providing a reference image showing a reference scene, a reference point cloud of the reference scene, and a corresponding reference pose of the camera used to acquire the reference image, wherein the point cloud of the scene overlaps the point cloud of the reference point cloud of the reference scene, the method further comprising, after all the iterations have been carried out to obtain a final 6D pose of the camera of the first image, optimizing the final 6D pose using the reference pose of the camera used to acquire the reference image.

8. The method according to claim 1, comprising a preliminary joint training phase of the image processing neural network and of the point cloud processing neural network.

9. A system configured to perform the method according to claim 1.

10. (canceled)

11. A non-transitory storage medium storing instructions that are executable by one or more processors and that cause the one or more processors to perform functions of the method according to claim 1.
